(19) United States
(12) Patent Application Publication
(10) Pub. No.: US 2009/0125606 A1
(43) Pub. Date: May 14, 2009

(54) COMMUNICATION APPARATUS AND REMOTE PROGRAM UPDATE METHOD

(75) Inventor: Noboru KAMEI, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/257,052

(22) Filed: Oct. 23, 2008

(30) Foreign Application Priority Data
Nov. 9, 2007 (JP) 2007-292620

(51) Int. Cl. G06F 15/16

(52) U.S. Cl. 709/217

(57) ABSTRACT

A communication apparatus forming a predetermined communication network as a node apparatus has an operation controlled by a predetermined control program. The communication apparatus transmits update data to another communication apparatus of the predetermined communication network, where the update data is multiplexed with communication data, separates the update data from the communication data, and updates data of the predetermined control program in a pertinent communication apparatus, with the update data of the predetermined control program.

### CROSS-REFERENCE TO RELATED APPLICATIONS

This application is based upon and claims the benefit of priority of Japanese Patent Application No. 2007-292620, filed on Nov. 9, 2007, the entire contents of which are incorporated herein by reference.

### FIELD

The embodiments discussed herein are directed to a communication apparatus which constitutes a predetermined communication network as a node apparatus and whose operation is controlled by a predetermined control program, and a remote program update method which updates the predetermined control program from a remote site.

### BACKGROUND

A communication apparatus which constitutes a communication network as a node apparatus generally has its operation controlled by a predetermined control program. Such communication apparatuses are respectively installed in individual offices which disperse geographically. That is, the communication apparatuses disperse geographically. Therefore, in case of updating the predetermined control program to the newest version, it has heretofore been common practice that an operator arrives at each of the offices, and that he/she performs the update operation of the control program by connecting a terminal device every communication apparatus. Accordingly, the update operation of the control program has been laborious.

For this reason, there have been proposed various methods for updating the control program in remote fashion by utilizing the communication network. By way of example, JP-A-2003-92602 has proposed the following network apparatus. First, the network apparatus inquires of the adjacent network apparatus about the version No. of the program or the like data. Subsequently, in a case where the version No. in the adjacent network apparatus is newer than the version No, of the data stored in the network apparatus itself, the network apparatus issues a transmission request for the data, to the adjacent network apparatus. In addition, the network apparatus receives the data of the newer version No. from the adjacent network apparatus and stores the received data therein.

JP-A-2006-92451 has proposed a mobile terminal device that accumulates updated software which is included in a digital broadcast signal. In addition, with the closure of a power source as a trigger, the mobile terminal device updates software in the device itself, with the accumulated updated software.

JP-A-2002-312274 has proposed the following program download method. A subordinate apparatus having judged that the update of program data is necessary, requests a host apparatus to download program data. In compliance with the request, the host apparatus downloads the program data from a download apparatus. The host apparatus transmits the program data to the subordinate apparatus through a transmission line which transmits the program data in multiplexing on communication data. The subordinate apparatus separates the program data from the communication data, and retains the program data.

### SUMMARY

According to an aspect of an embodiment, a communication apparatus forming a predetermined communication network as a node apparatus, and which has an operation controlled by a predetermined control program, the apparatus includes: a control-program update data multiplexing transmission unit which transmits update data of the predetermined control program to another communication apparatus of the predetermined communication network, said update data being multiplexed with, at least in part with communication data; a control-program update data separation unit which separates the update data from the communication data, when the communication data multiplexed with the update data is received; and a control-program data update unit which updates data of the predetermined control program in a pertinent communication apparatus, with the update data of the predetermined control program as separated by said control-program update data separation unit.

### BRIEF DESCRIPTION OF DRAWINGS

FIG. 1 is a functional block diagram showing a configuration of a communication apparatus according to an embodiment;

FIG. 2A is a diagram showing an example of a frame format of configuration data;

FIG. 2B is a diagram showing an example of a frame format of a configuration data update result signal;

FIG. 3A is a diagram showing a SONET/SDH frame format;

FIG. 3B is a diagram showing an OTN frame format;

FIG. 4 is a diagram showing an exchange situation of configuration data between communication apparatuses according to an embodiment;

FIG. 5 is a flow chart showing an update processing procedure for configuration data;

FIG. 6 is a diagram (#1) showing an exchange situation of configuration data in a case where communication apparatuses according to an embodiment are in a ring configuration;

FIG. 7 is a diagram (#2) showing an exchange situation of configuration data in a case where communication apparatuses according to an embodiment are in a ring configuration; and

FIG. 8 is a diagram (#3) showing an exchange situation of configuration data in a case where communication apparatuses according to an embodiment are in a ring configuration.

### DESCRIPTION OF EMBODIMENTS

Embodiments of a communication apparatus and a remote program update method will be described in detail with reference to the accompanying drawings. Incidentally, a communication network in which the communication apparatuses to be illustrated in the embodiments below are used as nodes is a communication network which uses an optical transmission line such as the SONET/SDH (Synchronous Optical NETwork/Synchronous Digital Hierarchy) or the OTN (Optical Transport Network). The embodiments, however, are not restricted to the above communication network, or any particular network. For example, embodiments are also applicable to an IP (Internet Protocol) packet communication network such as ETHERNET (registered trademark), a radio communication network, or any other similar network.

Each of the communication apparatuses illustrated in the embodiments discussed below is illustrated as being accommodated in one office. It is also assumed that such offices are arranged in geographical dispersion. In other words, it is premised that the communication apparatuses illustrated in the embodiments below are arranged in geographical dispersion.

Besides, in the embodiments described below, a control circuit of the communication apparatus is illustrated as an FPGA (Field Programmable Gate Array). The control program of the FPGA is referred to as a “configuration”, and the control program data of the FPGA is referred to as “configuration data”.

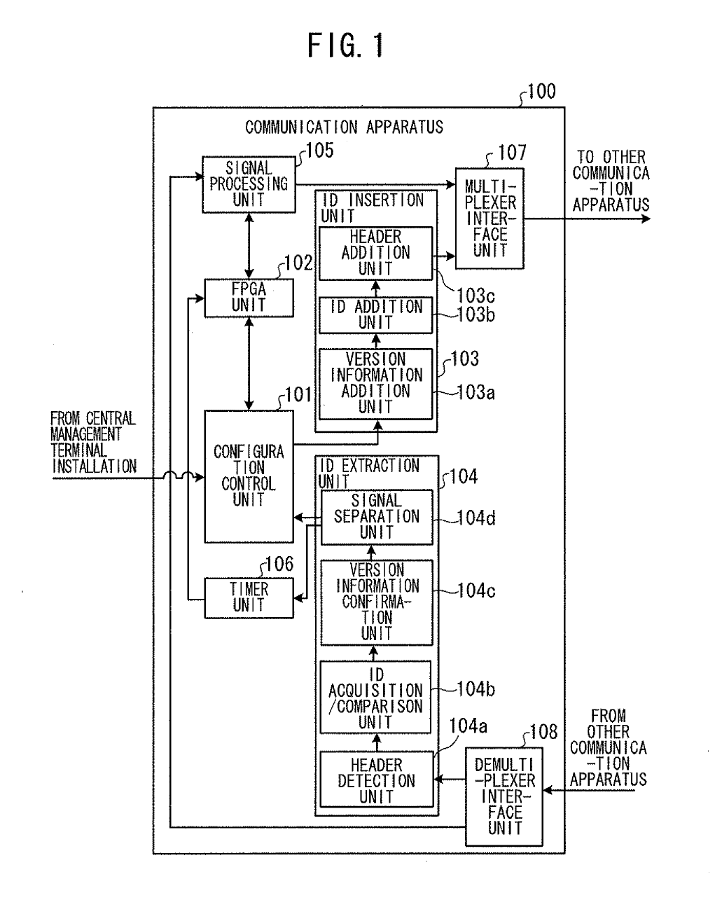

First, the configuration of the communication apparatus according to an embodiment will be described. FIG. 1 is a functional block diagram showing a fundamental configuration of the communication apparatus according to an embodiment. In order to explain the embodiment briefly, the communication apparatus 100 shown in FIG. 1 communicates with other communication apparatuses through a single transmission line. The other communication apparatus being the signal output destination of the communication apparatus 100 and the signal input source which may be identical or may be different.

The communication apparatus 100 shown in FIG. 1 includes a configuration control unit 101, an FPGA unit 102, an ID insertion unit 103, an ID extraction unit 104, a signal processing unit 105 which transfers communication data received from the other communication apparatus, to the still other communication apparatus, a timer unit 106, a multiplexer interface unit 107 and a demultiplexer interface unit 108.

The configuration control unit 101 governs (controls) a process for updating the configuration data. This configuration control unit 101 is a microcomputer or the like control device. It separates (demultiplexes) updating configuration data for the FPGA unit 102, from updating configuration data inputted from a central management terminal installation located outside. The separated updating configuration data is delivered to the FPGA unit 102 to update the configuration data. Simultaneously, the configuration control unit 101 separates updating configuration data for an FPGA unit of another communication apparatus, from the inputted updating configuration data, and delivers the separated updating configuration data to the ID insertion unit 103.

Incidentally, the updating configuration data for the FPGA unit 102 and the updating configuration data for the FPGA unit of the other communication apparatus, which are separated from the updating configuration data inputted from the external terminal installation, may be either identical data or different data.

The FPGA unit 102 transmits a control signal to the signal processing unit 105 in accordance with control based on the stored configuration data. The signal processing unit 105 responsively transmits an alarm signal to the FPGA unit 102 in a case where any abnormality has occurred.

The ID insertion unit 103 further includes a version information addition unit 103a, an ID addition unit 103b and a header addition unit 103c. The version information addition unit 103a adds version information to the updating configuration data delivered from the configuration control unit 101.

Incidentally, when the version information addition unit 103a has had a configuration data update result signal delivered from the configuration control unit 101, it delivers the configuration data update result signal to the ID addition unit 103b directly without requiring execution of processing.

Subsequently, the ID addition unit 103b adds an ID (identification information) of the communication apparatus of the transmission destination of the updating configuration data, to the updating configuration data in which the version information has been added by the version information addition unit 103a. Further, the header addition unit 103c adds header information to the updating configuration data in which the ID has been added by the ID addition unit 103b, and it delivers the resulting updating configuration data to the multiplexer interface unit 107.

The multiplexer interface unit 107 multiplexes main signal data delivered from the signal processing unit 105 and the updating configuration data delivered from the ID insertion unit 103, and it sends the multiplexed data to the opposing apparatus.

The ID extraction unit 104 further includes a header detection unit 104a, an ID acquisition/comparison unit 104b, a version information confirmation unit 104c and a signal separation unit 104d. The demultiplexer interface unit 108 separates updating configuration data, from reception data received from the opposing apparatus, and it outputs the separated updating configuration data to the header detection unit 104a of the ID extraction unit 104. The header detection unit 104a detects the header of the updating configuration data.

The demultiplexer interface unit 108 separates a configuration data update result signal in the other communication apparatus, from the reception data received from the opposing apparatus, and it outputs the separated signal to the header detection unit 104a. The header detection unit 104a detects the header of the inputted configuration data update result signal.

Subsequently, the ID acquisition/comparison unit 104b acquires an ID added to the updating configuration data (or the configuration data update result signal) whose header has been detected by the header detection unit 104a. Besides, the ID acquisition/comparison unit 104b compares the acquired ID and the ID of the apparatus of its own, so as to decide whether or not the IDs agree. The ID acquisition/comparison unit 104b delivers the updating configuration data (or the configuration data update result signal) to the version information confirmation unit 104c, in a case where the ID added to the updating configuration data (or the configuration data update result signal) agrees with the ID of the apparatus of this unit 104b.

On the other hand, the ID acquisition/comparison unit 104b annuls the updating configuration data (or the configuration data update result signal), in a case where the ID added to the updating configuration data does not agree with the ID of the apparatus of this unit 104b.

The version information confirmation unit 104c acquires version information added to the updating configuration data delivered from the ID acquisition/comparison unit 104b. Then, the version information confirmation unit 104c decides whether or not the acquired version information is newer than the version information of the configuration data stored in the apparatus of this unit 104c. Subject to the decision that the acquired version information is newer, the version information confirmation unit 104c delivers the updating configuration data to the signal separation unit 104d.

On the other hand, in a case where the acquired version information has not been decided to be newer, the version information confirmation unit 104c annuls the updating configuration data.

Incidentally, when the version information confirmation unit 104c has had the configuration data update result signal delivered from the ID acquisition/comparison unit 104b, it delivers the signal to the signal separation unit 104d directly.

The signal separation unit 104d delivers the updating configuration data delivered from the version information confirmation unit 104c, to the configuration control unit 101. This signal separation unit 104d separates a restart signal added to the updating configuration data, and delivers the restart signal to the timer unit 106.

Incidentally, the timer unit 106 having had the restart signal delivered from the ID extraction unit 104 transmits a reset signal to the FPGA unit 102 after a predetermined time period. With the reset signal as a trigger, the FPGA unit 102 updates the configuration data with the updating configuration data which have been delivered from the ID extraction unit 104 through the configuration control unit 101.

Incidentally, when the signal separation unit 104d has had the configuration data update result signal delivered from the version information confirmation unit 104c, it delivers the signal to the configuration control unit 101 directly.

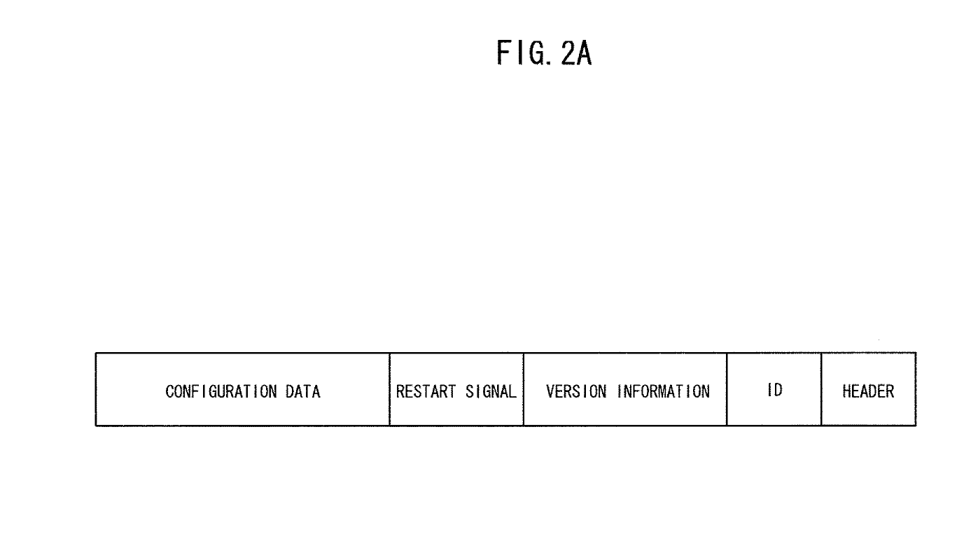

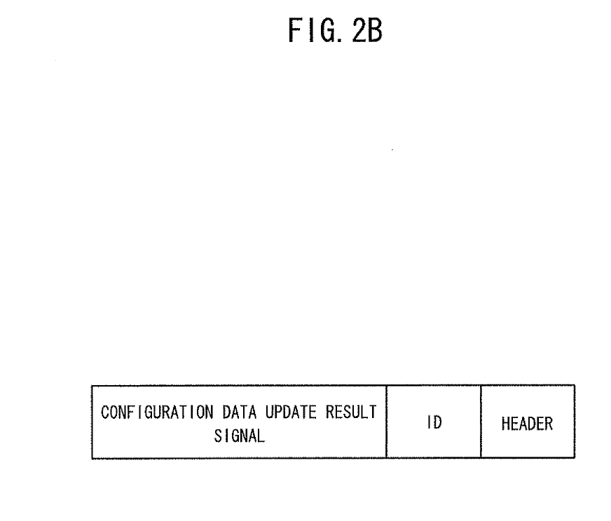

Next, frame format of the updating configuration data which are used in the communication apparatus 100 shown in FIG. 1 is described below in detail. FIG. 2A is a diagram showing an example of the configuration data frame format. As shown in FIG. 2A, in a configuration data frame, a restart signal, version information, an ID and a header are stored behind the configuration data. The restart signal, the version information and the ID are the same as described above. Besides, the header is the predetermined header information of the configuration data frame.

Next, there will be described the frame format of a configuration data update result signal which is used in the communication apparatus 100 shown in FIG. 1. FIG. 2B is a diagram showing an example of the configuration data update result signal frame format. As shown in FIG. 2B, in a configuration data update result signal frame, an ID and a header are stored behind the configuration data update result signal (which indicates data update normal completion or data update abnormal completion). The ID relates to identification of the communication apparatus of the transmission source from which the updating configuration data has been inputted. The ID is added in the communication apparatus whose configuration data have been updated with the updating configuration data transmitted from the communication apparatus 100. The header is the predetermined header information of the configuration data update result signal frame.

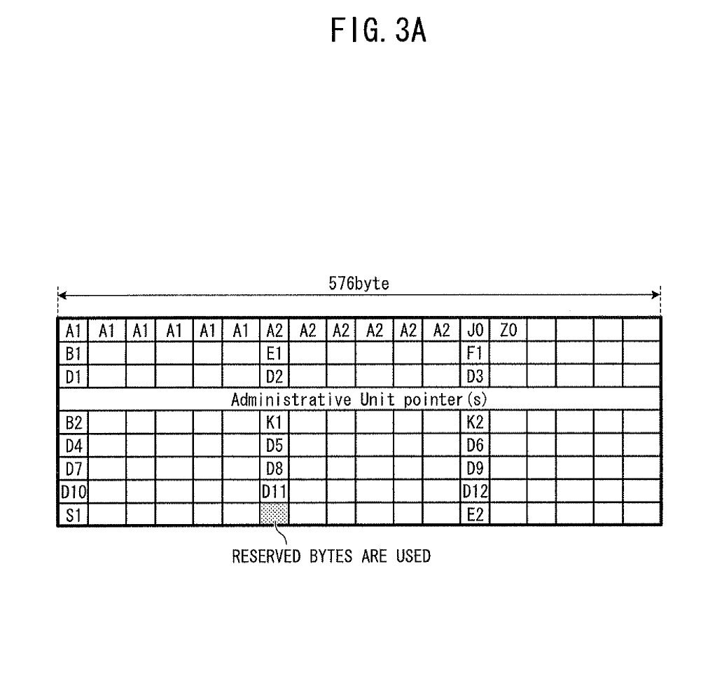

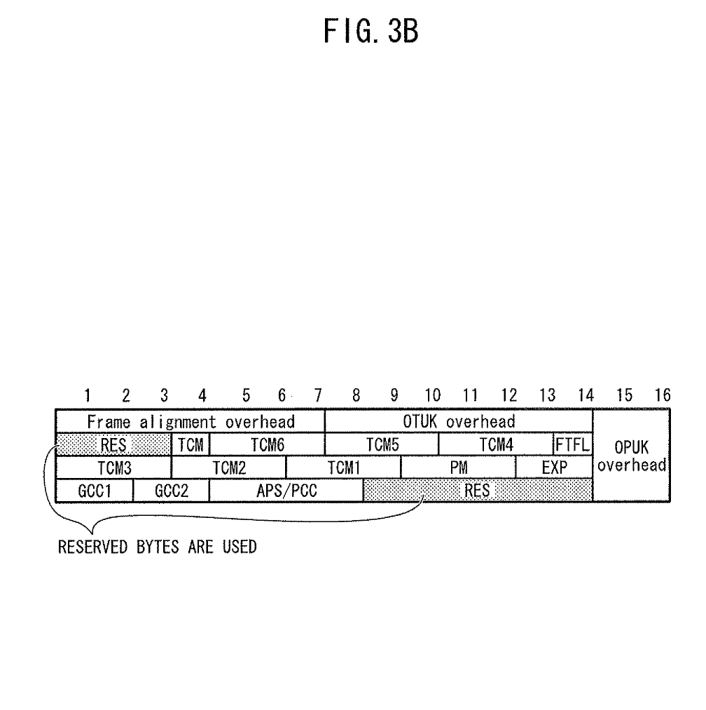

Next, there will be described a frame format for multiplexing (or embedding) the configuration data frame shown in FIG. 2A and the configuration data update result signal frame shown in FIG. 2B. FIG. 3A is a diagram showing a SONET/SDH frame format in the case where the communication network is the SONET/SDH (STM64). In a SONET/SDH frame shown in FIG. 3A reserved bytes stipulated in G707 as are used for embedding the configuration data frame and the configuration data update result signal frame.

FIG. 3B is a diagram showing reserved bytes stipulated in G709 as are used for embedding the configuration data frame and the configuration data update result signal frame in an OTN frame in a case where the communication network is the OTN.

In this manner, the reserved bytes of one SONET/SDH frame or one OTN frame have a limited storable information quantity. In contrast, the configuration data frame has as large a data size as several kilobytes to several megabytes. Therefore, the configuration data frame or the configuration data update result signal frame is divided so as to be stored in the reserved bytes of a plurality of SONET/SDH frames or OTN frames.

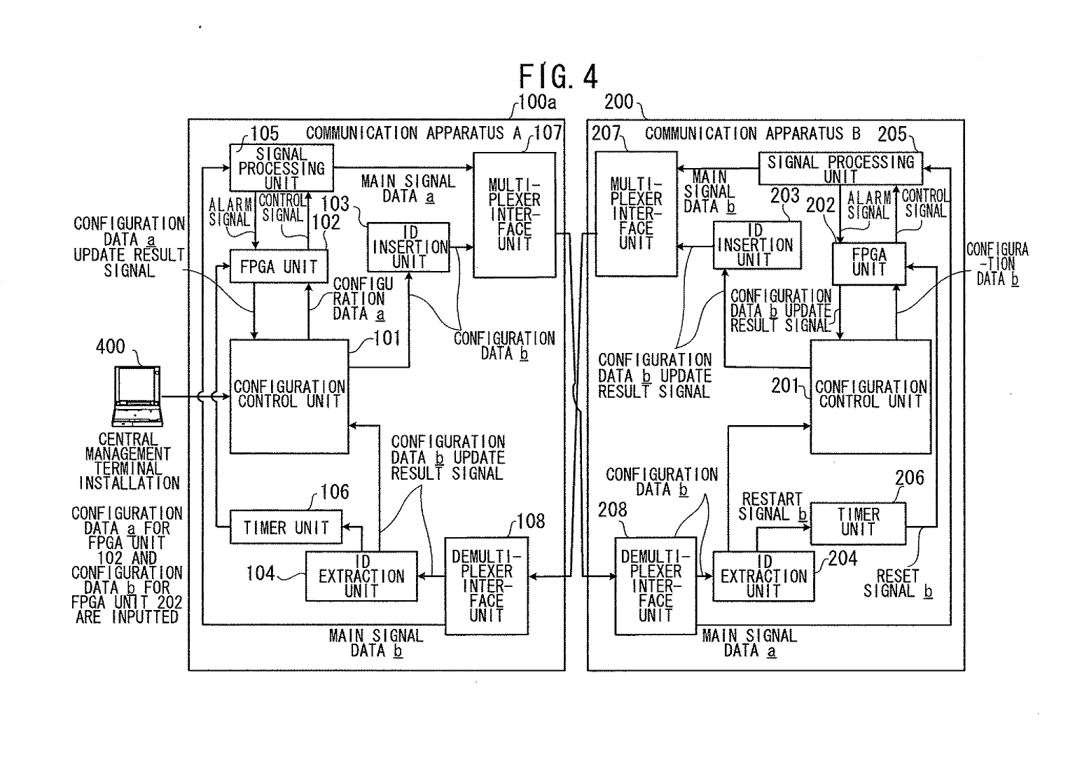

Next, exchange of the configuration data between the communication apparatuses according to an embodiment is described below in detail. FIG. 4 is a diagram showing the exchange of the configuration data between the communication apparatuses according to an embodiment. FIG. 4 shows a situation where the communication apparatus A 100a and the communication apparatus B 200 are connected in opposition. Although, in FIG. 4, the opposing connection is illustrated for the brevity of description, this configuration is not restrictive, but a ring configuration or any other connection configuration may well be used.

Each of the communication apparatus A 100a and the communication apparatus B 200 has the same configuration as that of the foregoing communication apparatus 100. Under this situation, a central management terminal installation 400 is connected to the configuration control unit 101 of the communication apparatus A 100a as shown in FIG. 4. Configuration data a for the FPGA unit 102 of the communication apparatus A 100a, and configuration data b for the FPGA unit 202 of the communication apparatus B 200 are inputted from the central management terminal installation 400 to the configuration control unit 101.

The configuration control unit 101 delivers the configuration data a to the FPGA unit 102. The FPGA unit 102 updates its configuration data with the configuration data a. In addition, the FPGA unit 102 transmits a configuration data a update result signal to the configuration control unit 101.

Further, the configuration control unit 101 delivers the configuration data b to the ID insertion unit 103. The ID insertion unit 103 adds version information, an ID and a header to the configuration data b, and delivers the resulting data b to the multiplexer interface unit 107. The multiplexer interface unit 107 multiplexes the configuration data b on main signal data a from the signal processing unit 105, and transmits the multiplexed data to the communication apparatus B 200.

The communication apparatus B 200 receives the transmission data from the communication apparatus A 100a, in which the configuration data b have been multiplexed with the main signal data a, by the demultiplexer interface unit 208 of this communication apparatus. The demultiplexer interface unit 208 separates the reception data into the main signal data a and the configuration data b.

In addition, the demultiplexer interface unit 208 transmits the main signal data a to the signal processing unit 205 of the communication apparatus B 200. Besides, the configuration data b are delivered to the ID extraction unit 204 of the communication apparatus B 200. The ID extraction unit 204 delivers the configuration data b to the configuration control unit 201 of the communication apparatus B 200 for the reasons that the configuration data b are data directed to the apparatus of this unit 204 and that the configuration data b are newer in version than the configuration data stored in the apparatus of this unit 204. Simultaneously, the ID extraction unit 204 delivers a restart signal b added to the configuration data b, to the timer unit 206 of the communication apparatus B 200. The timer unit 206 transmits the reset signal b to the FPGA unit 202 on the basis of the restart signal b.

The configuration control unit 201 to which the configuration data b have been delivered, delivers the configuration data b to the FPGA unit 202. The FPGA unit 202 updates the configuration data with the configuration data b. In addition, the FPGA unit 202 delivers a configuration data b update result signal to the configuration control unit 201.

The configuration control unit 201 having received the configuration data b update result signal delivers this signal to the ID insertion unit 203 of the communication apparatus B 200. The ID insertion unit 203 adds an ID and a header to the configuration data b update result signal, and delivers the resulting signal to the multiplexer interface unit 207 of the communication apparatus B 200. The multiplexer interface unit 207 multiplexes the configuration data b update result signal on main signal data b from the signal processing unit 205, and transmits the multiplexed data to the communication apparatus A 100a.

The communication apparatus A 100a receives the transmission data from the communication apparatus B 200, in which the configuration data b update result signal has been multiplexed with the main signal data b, by the demultiplexer interface unit 108. The demultiplexer interface unit 108 separates the reception data into the main signal data b and the configuration data b update result signal.

In addition, the demultiplexer interface unit 108 transmits the main signal data b to the signal processing unit 105. Besides, the configuration data b update result signal is delivered to the ID extraction unit 104. The ID extraction unit 104 delivers the configuration data b update result signal to the configuration control unit 101 for the reason that the configuration data b update result signal is data directed to the apparatus of this unit 104.

If the configuration data b update result signal indicates the “update abnormal completion”, the configuration control unit 101 executes a process for resending the configuration data b to the communication apparatus B 200. The resending process is the same as a process in the case where the configuration data b were first transmitted to the communication apparatus B 200.

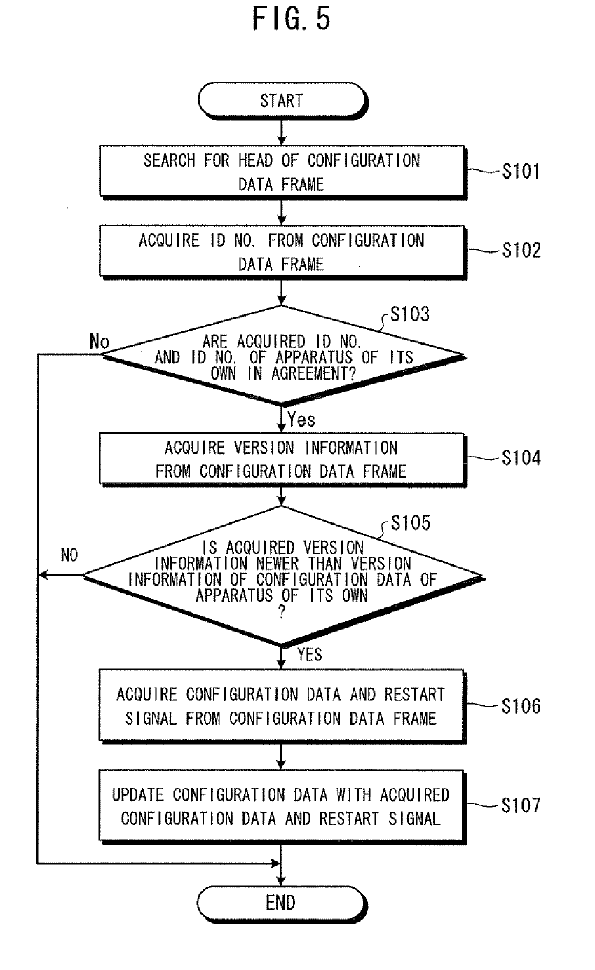

Next, a configuration data update process which is executed in the communication apparatus shown in FIG. 1 is described below in detail. FIG. 5 is a flow chart showing an update processing procedure for the configuration data. The process is executed in the case where the data in which the configuration data are multiplexed have been received from the other communication apparatus, and where the configuration data have been separated. As shown in FIG. 5, the header detection unit 104a, for example, searches for a header part at the head of a received configuration data frame (operation S101).

Subsequently, the ID acquisition/comparison unit 104b acquires an ID No. from the received configuration data frame (operation S102). Subsequently, the ID acquisition/comparison unit 104b, for example, decides (determines) whether or not the acquired ID No. and the ID No. of the apparatus of its own are in agreement (operation S103). Subject to the decision that the acquired ID No. and the ID No. of the apparatus of the unit 104b are in agreement (operation S103: “Yes”), the process shifts to a operation S104. In a case where the IDs have not been decided to agree (operation S103: “No”), the configuration data update process is ended.

Subsequently, the version information confirmation unit 104c, for example, acquires version information from the received configuration data frame (operation S104). Subsequently, the version information confirmation unit 104c, for example, decides whether or not the acquired version information is newer than the version information of the configuration data of the apparatus of its own (operation S105). Subject to the decision that the acquired version information is newer than the version information of the configuration data of the apparatus of the unit 104c (operation S105: “Yes”), the process shifts to a operation S106. In a case where the acquired version information has not been decided to be newer than the version information of the configuration data of the apparatus of the unit 104c (operation S105:: “No”), the configuration data update process is ended.

Subsequently, the signal separation unit 104d, for example acquires the configuration data and a restart signal from the configuration data frame (operation S106). Subsequently, the configuration control unit 101 updates the configuration data of the FPGA unit 102 with the acquired configuration data at the timing of a reset signal based on the restart signal (operation S107).

In accordance with the above process, the updating configuration data are transmitted in multiplexing on the communication data of the communication network, and hence, the communication traffic of the communication network is not increased. Even when the configuration data differ for respective communication apparatuses to-be-handled, they can be individually updated at a remote site. Since an operator need not update the configuration data by manual operations for the respective communication apparatuses, a personnel cost is curtailed. Moreover, since a communication circuit for transmitting the configuration data need not be separately laid, reduction in installation building expenses can be attained. Besides, the data of the control program can be efficiently installed at a lower cost and in a shortened operation time period.

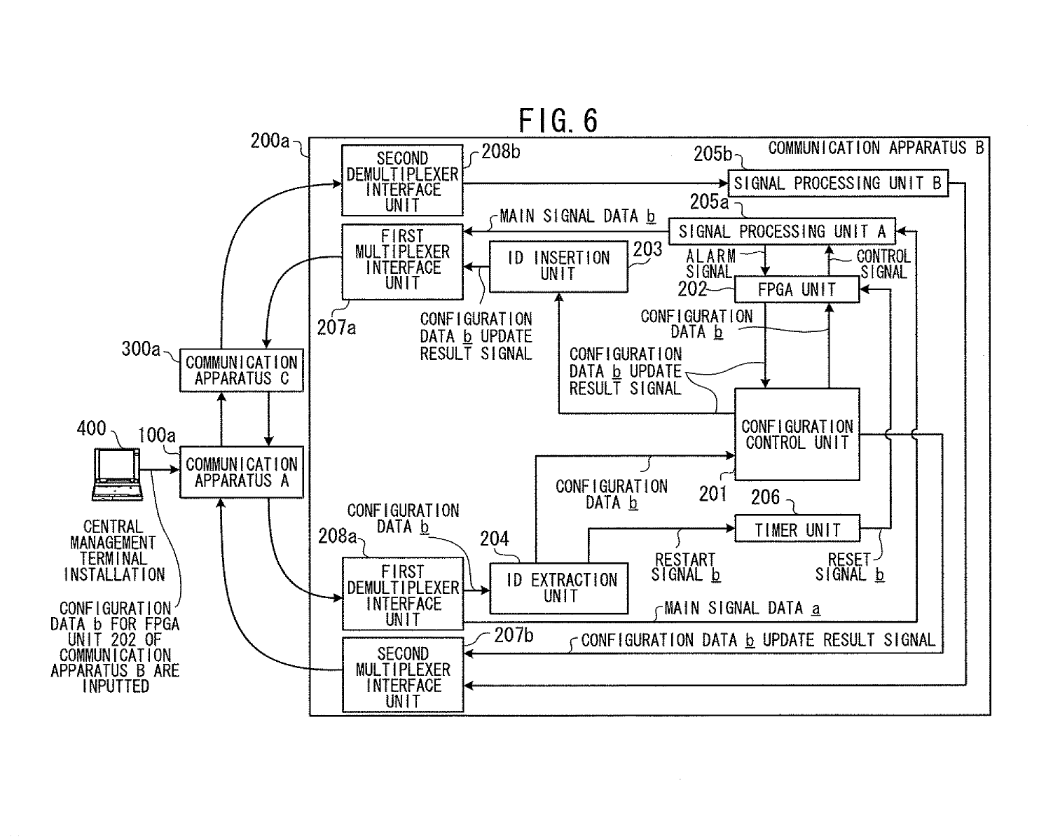

A first example in which the communication apparatuses according to an embodiment are arranged at ring-shaped nodes, and in which the nodes are connected by communication circuits of dualized ring configurations is described below in detail. FIG. 6 is a diagram (#1) showing the exchange situation of configuration data in the case where the communication apparatuses according to an embodiment are in the ring configuration. In this example, the communication circuit of one ring configuration in the communication circuits of the dual ring configurations is used.

The communication apparatus A 100a, communication apparatus B 200a and communication apparatus C 300a shown in FIG. 6 maybe identical in configuration. Under this situation, the configuration data b for the FPGA unit 202 of the communication apparatus B 200a are inputted from a central management terminal installation 400 which is connected to the configuration control unit 101 of the communication apparatus A 100a.

The communication apparatus A 100a transmits communication data on which the updating configuration data b are multiplexed, to the communication apparatus B 200a being the next node adjacent in the communication circuit of one ring configuration, by using this communication circuit. In the communication apparatus B 200a having received the communication data, the first demultiplexer interface unit 208a separates main signal data a and the configuration data b from the reception data. The first demultiplexer interface unit 208a delivers the main signal data a to the signal processing unit A 205a of the communication apparatus B 200a. Besides, the first demultiplexer interface unit 208a delivers the configuration data b to the ID extraction unit 204 of the communication apparatus B 200a.

The ID extraction unit 204 delivers the configuration data b to the configuration control unit 201 of the communication apparatus B 200a for the reason that the configuration data b are the configuration data directed to the communication apparatus B 200a. Simultaneously, the ID extraction unit 204 delivers a restart signal b added to the configuration data b, to the timer unit 206 of the communication apparatus B 200a.

In addition, the configuration control unit 201 delivers the configuration data b to the FPGA unit 202. The FPGA unit 202 updates its configuration data with the configuration data b at the timing of a reset signal b based on the restart signal b, from the timer unit 206.

The FPGA unit 202 having updated the configuration data delivers a configuration data b update result signal to the configuration control unit 201. The configuration control unit 201 delivers the configuration data b update result signal to the ID insertion unit 203 of the communication apparatus B 200a. The ID insertion unit 203 adds the ID of the communication apparatus A 100a being the transmission source of the configuration data b, to the frame format of the configuration data b update result signal.

In addition, the ID insertion unit 203 delivers the configuration data b update result signal to the first multiplexer interface unit 207a of the communication apparatus B 200a. The first multiplexer interface unit 207a multiplexes main signal data b from the signal processing unit A 205a and the configuration data b update result signal. Thereafter, the first multiplexer interface unit 207a transmits the multiplexed data to the communication apparatus C 300a which is the next node adjacent in the communication circuit of the ring configuration.

The communication apparatus C 300a does not accept the configuration data b update result signal multiplexed with the communication data received from the communication apparatus B 200a, for the reason that the configuration data b update result signal is not data directed to this communication apparatus C 300a itself. Then, the communication apparatus C 300a transmits the configuration data b update result signal multiplexed with the communication data, to the communication apparatus A 100a which is the next node adjacent in the communication circuit of the ring configuration.

The communication apparatus A 100a accepts the configuration data b update result signal multiplexed with the communication data received from the communication apparatus C 300a, for the reason that the configuration data b update result signal is data directed to this communication apparatus A 100a. If the configuration data b update result signal indicates “update normal completion”, the communication apparatus A 100a ends processing directly. On the other hand, if the configuration data b update result signal indicates “update abnormal completion”, the communication apparatus A 100a transmits communication data on which the updating configuration data b are multiplexed, to the communication apparatus B 200a being the next node adjacent in the communication circuit, again.

In accordance with the above example, the communication circuit of one ring configuration in the communication circuits of the dual ring configurations is used for updating the configuration data of the FPGA unit of the pertinent apparatus itself. The updating configuration data are transmitted in multiplexing on the ordinary communication data, and with the destination communication apparatus designated. Each time the communication data go via the communication apparatus being the node of the ring, whether or not the updating configuration data directed to the pertinent apparatus itself are multiplexed is decided. Besides, in a case where the updating configuration data directed to the pertinent apparatus itself are multiplexed, the configuration data of the FPGA unit of the pertinent apparatus itself are updated.

In addition, the configuration data update result signal is transmitted by multiplexing with the ordinary communication data, and by designating the communication apparatus that is the transmission source of the updating configuration data. Each time the communication data gets transmitted via the communication apparatus being the node of the ring, whether or not the configuration data update result signal directed to the pertinent apparatus itself is multiplexed is decided. In a case where the configuration data update result signal directed to the pertinent apparatus itself is multiplexed, this signal is accepted. In addition, if the update result indicated by the signal is the “update abnormal completion”, the communication apparatus being the transmission source of the updating configuration data transmits the updating configuration data in multiplexing on the ordinary communication data and with the destination communication apparatus designated, again.

In this manner, in accordance with the example, when the communication circuit of one ring configuration in the communication circuits of the dual ring configurations is used, the ID insertion unit 203 and the ID extraction unit 204 may be prepared in one set for one transmission line, so that the configuration of the communication apparatus according to the embodiment is simplified, and a fabrication cost can be reduced. Accordingly, the disclosed method provides remote configuration-data updating process according to an embodiment.

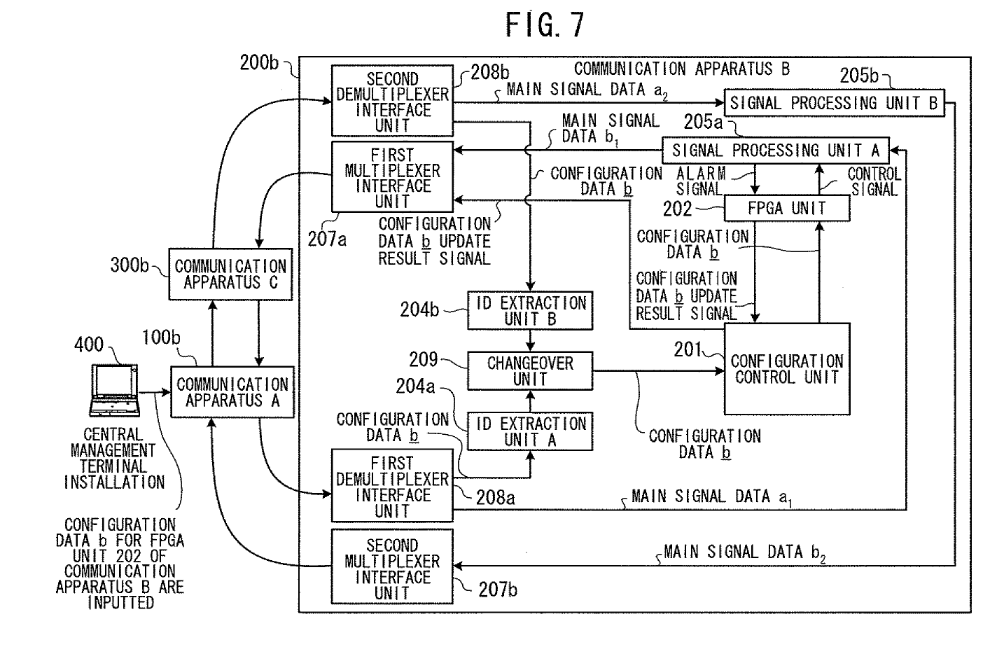

A second example in which the communication apparatuses according to an embodiment are arranged at ring-shaped nodes, and in which the nodes are connected by communication circuits of dualized ring configurations is described below in detail. FIG. 7 is a diagram (#2) showing the exchange situation of configuration data in the case where the communication apparatuses according to the embodiment are in the ring configuration. In this example, the updating configuration data are transmitted using the communication circuits of both the dual ring configurations, and a configuration data update result signal is transmitted using the communication circuit of one ring configuration.

The communication apparatus A 100b, communication apparatus B 200b and communication apparatus C 300b shown in FIG. 7 may be identical in configuration. Under this situation, the configuration data b for the FPGA unit 202 of the communication apparatus B 200b are inputted from a central management terminal installation 400 which is connected to the configuration control unit 101 of the communication apparatus A 100b.

Using the communication circuits of both the ring configurations, the communication apparatus A 100b transmits communication data on which the updating configuration data b are multiplexed, to the communication apparatus B 200b and the communication apparatus C 300b being the next nodes adjacent in these communication circuits. In the communication apparatus B 200b having received the communication data, the first demultiplexer interface unit 208a thereof separates main signal data a₁ and the configuration data b from the reception data. The first demultiplexer interface unit 208a delivers the main signal data a₁ to the signal processing unit A 205a of the communication apparatus B 200b. This first demultiplexer interface unit 208a delivers the configuration data b to the ID extraction unit A 204a of the communication apparatus B 200b.

The ID extraction unit A 204a delivers the configuration data b to the changeover unit 209 of the communication apparatus B 200b, for the reason that the configuration data b are the configuration data directed to the communication apparatus B 200b.

On the other hand, the communication apparatus C 300b having received the communication data does not accept the configuration data b, for the reason that the configuration data b multiplexed with the communication data are not directed to this apparatus itself. Then, the communication apparatus C 300b having received the communication data transmits the configuration data b multiplexed with the communication data, to the communication apparatus B 200b which is the next node adjacent in the communication circuit of the ring configuration.

In the communication apparatus B 200b having received the communication data from the communication apparatus C 300b, the second demultiplexer interface unit 208b thereof separates main signal data a₂ and the configuration data b from the reception data. The second demultiplexer interface unit 208b delivers the main signal data a₂ to the signal processing unit B 205b of the communication apparatus B 200b. This second demultiplexer interface unit 208b delivers the configuration data b to the ID extraction unit B 204b of the communication apparatus B 200b.

The ID extraction unit B 204b delivers the configuration data b to the changeover unit 209, for the reason that the configuration data b are the configuration data directed to the communication apparatus B 200b.

The changeover unit 209 selects either of the configuration data b delivered from the ID extraction unit A 204a and the ID extraction unit B 204b, and delivers the selected data b to the configuration control unit 201 of the communication apparatus B 200b.

In addition, the configuration control unit 201 delivers the configuration data b to the FPGA unit 202 of the communication apparatus B 200b. The FPGA unit 202 updates its configuration data with the configuration data b at the timing of a reset signal b based on a restart signal b, from the timer unit 206 (not shown) of the communication apparatus B 200b.

The FPGA unit 202 having updated the configuration data delivers a configuration data b update result signal to the configuration control unit 201. The configuration control unit 201 delivers the configuration data b update result signal to the ID insertion unit 203 (not shown) of the communication apparatus B 200b. The ID insertion unit 203 adds the ID of the communication apparatus A 100b being the transmission source of the configuration data b, to the frame format of the configuration data b update result signal.

In addition, the ID insertion unit 203 (not shown) delivers the configuration data b update result signal to the first multiplexer interface unit 207a of the communication apparatus B 200b. The first multiplexer interface unit 207a multiplexes the main signal data b1 from the signal processing unit A 205a and the configuration data b update result signal, and transmits the multiplexed data to the communication apparatus C 300b which is the next node adjacent in the communication circuit of the ring configuration.

The communication apparatus C 300b does not accept the configuration data b update result signal which is multiplexed with the communication data received from the communication apparatus B 200b, for the reason that the configuration data b update result signal is not data directed to this communication apparatus C 300b itself. The communication apparatus C 300b transmits the configuration data b update result signal multiplexed with the received communication data, to the communication apparatus A 100b which is the next node adjacent in the communication circuit of the ring configuration.

The communication apparatus A 100b accepts the configuration data b update result signal which is multiplexed with the communication data received from the communication apparatus C 300b, for the reason that the configuration data b update result signal is data directed to this communication apparatus A 100b itself. If the configuration data b update result signal indicates “update normal completion”, the communication apparatus A 100b ends processing directly. On the other hand, if the configuration data b update result signal indicates “update abnormal completion”, the communication apparatus A 100b transmits communication data on which the updating configuration data b are multiplexed, to the communication apparatus B 200b being the next node adjacent in the communication circuit, again.

In accordance with the above example, the configuration data are transmitted using the communication circuits of the two ring configurations redundantly. Therefore, even when any fault has occurred in the communication circuit of one ring configuration, the updating configuration data can be reliably delivered to the desired communication apparatus by using the communication circuit of the other ring configuration.

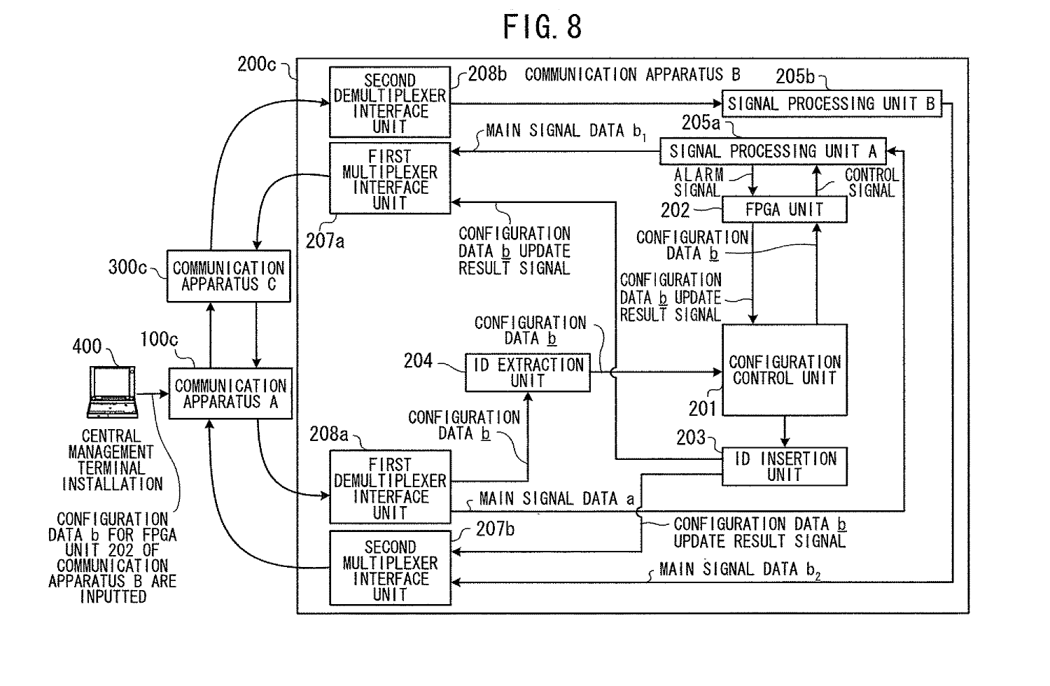

A third example in which the communication apparatuses according to an embodiment are arranged at ring-shaped nodes, and in which the nodes are connected by communication circuits of dualized ring configurations is described below in detail. FIG. 8 is a diagram (#3) showing the exchange of configuration data in the case where the communication apparatuses according to an embodiment are in the ring configuration. In this example, the updating configuration data are transmitted using the communication circuit of one ring configuration in the communication circuits of the dual ring configurations, and a configuration data update result signal is transmitted using the communication circuits of both the ring configurations.

The communication apparatus A 100c, communication apparatus B 200c and communication apparatus C 300c shown in FIG. 8 may be identical in configuration. Under this situation, the configuration data b for the FPGA unit 202 of the communication apparatus B 200c are inputted from a central management terminal installation 400 which is connected to the configuration control unit 101 of the communication apparatus A 100c.

Using the communication circuit of one ring configuration, the communication apparatus A 100c transmits communication data on which the updating configuration data b are multiplexed, to the communication apparatus B 200c being the next node adjacent in this communication circuit. In the communication apparatus B 200c having received the communication data, the first demultiplexer interface unit 208a thereof separates main signal data a and the configuration data b from the reception data. The first demultiplexer interface unit 208a delivers the main signal data a to the signal processing unit A 205a of the communication apparatus B 200c. This first demultiplexer interface unit 208a delivers the configuration data b to the ID extraction unit 204 of the communication apparatus B 200c.

The ID extraction unit 204 delivers the configuration data b to the configuration control unit 201 of the communication apparatus B 200c, for the reason that the configuration data b are configuration data directed to this communication apparatus B 200c. Simultaneously, the ID extraction unit 204 delivers a restart signal b added to the configuration data b, to the timer unit (not shown) of the communication apparatus B 200c.

In addition, the configuration control unit 201 delivers the configuration data b to the FPGA unit 202. The FPGA unit 202 updates its configuration data with the configuration data b at the timing of a reset signal b based on the restart signal b, from the timer unit 206 (not shown).

The FPGA unit 202 having updated the configuration data delivers the configuration data b update result signal to the configuration control unit 201. The configuration control unit 201 delivers the configuration data b update result signal to the ID insertion unit 203 of the communication apparatus B 200c. The ID insertion unit 203 adds the ID of the communication apparatus A 100c being the transmission source of the configuration data b, to the frame format of the configuration data b update result signal.

In addition, the ID insertion unit 203 delivers the configuration data b update result signal to both the first multiplexer interface unit 207a and second multiplexer interface unit 207b of the communication apparatus B 200c. The first multiplexer interface unit 207a multiplexes main signal data b₁ from the signal processing unit A 205a and the configuration data b update result signal, and transmits the multiplexed data to the communication apparatus C 300c being the next node adjacent in the communication circuit of the ring configuration. The second multiplexer interface unit 207b multiplexes main signal data b₂ from the signal processing unit B 205b of the communication apparatus B 200c and the configuration data b update result signal, and transmits the multiplexed data to the communication apparatus A 100c being the next node adjacent in the communication circuit of the ring configuration.

The communication apparatus A 100c delivers the configuration data b update result signals which are multiplexed with the communication data received from the communication apparatus B 200c and the communication apparatus C 300c, to the selector unit (not shown) of this communication apparatus A 100c, for the reason that the configuration data b update result signals are data directed to the communication apparatus A 100c itself, The selector unit selects either of the configuration data b update result signals. If the selected configuration data b update result signal indicates “update normal completion”, the communication apparatus A 100c ends processing directly. On the other hand, if the configuration data b update result signal indicates “update abnormal completion”, the communication apparatus A 100c transmits communication data on which the updating configuration data b are multiplexed, to the communication apparatus B 200c being the next node adjacent in the communication circuit, again.

Incidentally, the above selector unit may well be configured so as to select either of the communication data received from the communication apparatus B 200c and the communication apparatus C 300c, and to thereafter separate the configuration data b update result signal from the selected communication data.

In accordance with the above example, the configuration data update result signal is transmitted using the communication circuits of the two ring configurations redundantly. Therefore, even when any fault has occurred in the communication circuit of one ring configuration, the configuration data update result signal can be reliably delivered to the communication apparatus of the transmission source by using the communication circuit of the other ring configuration.

Incidentally, the three communication apparatuses are illustrated as the nodes in each of FIGS. 6, 7 and 8, but the number of the nodes is not restrictive. Besides, the central management terminal installation 400 can be connected to the configuration control unit of any of the communication apparatuses. That is, the updating configuration data can be transmitted from any of the communication apparatuses.

Although the embodiments have been described above, the apparatus and the method are not restricted to the illustrative embodiments.

The functions of the communication apparatus 100, communication apparatus A 100a, communication apparatus B 200a, communication apparatus B 200b and communication apparatus B 200c shown in the embodiments, respectively, can be simultaneously executed by one communication apparatus.

Besides, among the processes described in the embodiments, the processes which have been described to be automatically executed can also be manually executed entirely or partly. Alternatively, the processes which have been described to be manually executed can also be automatically executed by known methods, entirely or partly. Further, the processing procedures, control procedures, concrete appellations, and information items containing the various data and parameters as have been illustrated in the embodiments can be altered at will unless otherwise specified.

Besides, the individual constituents of the illustrated apparatuses have been given in functional concept fashion, and they need not always be physically configured as illustrated in the drawings. That is, the concrete aspects of the disintegration and integration of the respective apparatuses are not restricted to the illustrated ones, but the apparatuses can be functionally or physically disintegrated or integrated in arbitrary units in accordance with various loads, service situations, etc., entirely or partly.

Further, each of individual processing functions which are executed in the respective apparatuses has the entirety or any desired part thereof executed by a CPU (Central Processing Unit) (or a microcomputer such as an MPU (Micro Processing Unit) or an MCU (Micro Controller Unit)) and a program which is analyzed and run by the CPU (or the microcomputer such as the MPU or the MCU). Alternatively, the processing function may be implemented as hardware based on wired logic.

In accordance with the embodiments, the update data of the control program are transmitted in multiplexing on, at least, part of the communication data, to the other communication apparatus constituting (forming) the predetermined communication network. On the other hand, when the communication data on which the update data of the control program are multiplexed are received, the update data of the control program are separated from the communication data, and hence, the communication traffic of the communication network is not increased. Besides, the predetermined control program can be updated at a remote site. Therefore, an operator need not specially arrive at an office in which the communication apparatus is accommodated, in order to update the control program, so that a personnel cost is curtailed. Moreover, since the update data of the control program are transmitted using the communication network constituted by the communication apparatuses, any separate circuit (for example, an Internet circuit) for transmitting the update data of the control program need not be laid. This brings forth the advantage that the update data of the control program can be transmitted at a lower cost and at a higher efficiency. Besides, the data of the control program can be efficiently installed at a low cost and in a shortened operation time period.

Besides, in accordance with the embodiments, whether or not the update of the data of the predetermined control program by the control program update unit has been successful is notified to the communication apparatus which is the transmission source of the update data of the control program. When it is not notified that the update of the data of the predetermined control program has been successful, the communication apparatus being the transmission source transmits the update data of the control program in multiplexing on, at least, part of the communication data, to the corresponding communication apparatus again. Accordingly, the update of the predetermined control program can be reliably performed.

Besides, in accordance with the embodiments, the update data of the control program are stored in the reserved area of the predetermined frame of the communication data of the predetermined communication network. Thereafter, the update data of the control program are multiplexed and transmitted to the other communication apparatus constituting the predetermined communication network. Accordingly, the communication traffic of the communication network can be prevented from increasing.

In addition, in accordance with the embodiments, if the update data of the control program as directed to the pertinent communication apparatus itself have been multiplexed and transmitted can be discriminated by the identification information of the communication apparatus. Only in the case of the update data of the control program as directed to the pertinent apparatus itself, the update data are separated so as to update the predetermined control program. Thus, any unnecessary separation process for the update data of the control program is not executed. Accordingly, the processing can be made efficient. Moreover, the update data of the control program as differ for the respective communication apparatuses can be transmitted by designating the identification information items of the communication apparatuses.

Still in addition, in accordance with the embodiments, in the case of the update data of the control program as are not directed to the pertinent apparatus itself, the update data of the control program are not separated. Thus, any unnecessary separation process for the update data of the control program is not executed, and the processing can be made efficient. Moreover, since the communication data on which the update data of the control program are multiplexed are transferred, the communication apparatus requiring the update data of the control program can receive these update data.

Yet in addition, in accordance with the embodiments, since only either the transmission line based on the first ring configuration or the transmission line based on the second ring configuration is used, it suffices to prepare in only one transmission line, the processing functions of the multiplexing and separation of the update data of the control program, the notification of the update completion of the control program, the identification of the apparatuses, etc. Accordingly, the configuration of each communication apparatus can be simplified, and a fabrication cost can be reduced.

Further, in accordance with the embodiments, both the transmission line based on the first ring configuration and the transmission line based on the second ring configuration are used, and hence, even when one transmission line has been disconnected, the update data of the control program can be multiplexed and transmitted by the other transmission line. Accordingly, owing to the redundant transmission of the update data of the control program, it is possible to heighten a reliability at which the update data of the control program are received by the desired communication apparatus.

Still further, in accordance with the embodiments, both the transmission line based on the first ring configuration and the transmission line based on the second ring configuration are used, and hence, even when one transmission line has been disconnected, whether or not the update of the data of the predetermined control program has been successful can be notified by the other transmission line. Accordingly, owing to the redundant transmission of the update data of the control program, the update data of the control program can be received by the desired communication apparatus. It is therefore possible to heighten a reliability at which the control program is updated by the update data thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication apparatus forming a predetermined communication network as a node apparatus, and which has an operation controlled by a predetermined control program, the apparatus comprising:
a control-program update data multiplexing transmission unit which transmits update data of the predetermined control program to another communication apparatus of the predetermined communication network, said update data being multiplexed with, at least in part with communication data;
a control-program update data separation unit which separates the update data from the communication data, when the communication data multiplexed with the update data is received; and
a control-program data update unit which updates data of the predetermined control program in a pertinent communication apparatus, with the update data of the predetermined control program as separated by said control-program update data separation unit.

2. The communication apparatus according to claim 1, comprising:
a control-program data update notification unit which notifies whether an update of the data of the predetermined control program has been successful, to the communication apparatus being a transmission source of the update;
wherein, in a case where the update of the data of the predetermined control program has been successful, , said control-program update data multiplexing transmission unit transmits the update data of the predetermined control program multiplexed, at least in part with the communication data, to a corresponding communication apparatus that is a transmission destination again.

3. The communication apparatus according to claim 1, wherein the multiplexed update data of the predetermined control program is transmitted to the other communication apparatus of the predetermined communication network, by storing the update data of the predetermined control program in a reserved area of a predetermined frame of the communication data of the predetermined communication network.

4. The communication apparatus according to claim 1, wherein:
the predetermined communication network is a communication network including a transmission line that is configured by arranging a plurality of communication apparatuses in a ring shape as node apparatuses;
said control-program update data multiplexing transmission unit transmits identification information of the communication apparatus being a transmission destination of the update data of the predetermined control program, together with the update data of the predetermined control program, by multiplexing at least in part with the communication data;
said control-program update data separation unit includes an identification information decision unit which decides identification information of the communication data upon receipt of the communication data multiplexed with the update data and the identification information;
said control-program update data separation unit separates the update data of the predetermined control program that is multiplexed from the communication data, in a case where the identification information agrees with the apparatus identification information of the pertinent communication apparatus; and
said control-program data update unit updates the data of the predetermined control program in the pertinent apparatus, with the update data of the predetermined control program as separated by said control-program update data separation unit.

5. The communication apparatus according to claim 4, wherein said control-program update data separation unit includes:
a communication data transfer unit which transfers the communication data multiplexed with the update data and the identification information, to the communication apparatus being the node apparatus next to the pertinent apparatus in the communication network of the ring configuration, without separating the update data of the predetermined program from the communication data, in a case where the identification information does not agree with the apparatus identification information of the pertinent apparatus.

6. The communication apparatus according to claim 4, wherein:
the predetermined communication network is a communication network which has a transmission line including a first ring configuration, and a transmission line including a second ring configuration and being reverse in a transmission direction of the communication data to the transmission line including the first ring configuration; and
the communication data multiplexed with the update data and the identification information are transmitted and received using either of the transmission line including the first ring configuration and the transmission line including the second ring configuration.

7. The communication apparatus according to claim 6, wherein said control-program data update notification unit notifies whether an update of the data of the predetermined control program has been successful, to the communication apparatus being a transmission source of the update data of the predetermined control program, by using either of the transmission line including the first ring configuration and the transmission line including the second ring configuration.

8. The communication apparatus according to claim 4, wherein:
the predetermined communication network is a communication network which has a transmission line including a first ring configuration, and a transmission line including a second ring configuration and being reverse in a transmission direction of the communication data to the transmission line including the first ring configuration;
the communication data multiplexed with the update data and the identification information are transmitted and received using both the transmission line including the first ring configuration and the transmission line including the second ring configuration;
said control-program update data separation unit includes a selection unit which selects either of the communication data multiplexed with the update data and the identification information as received through the transmission line including the first ring configuration, and the communication data multiplexed with the update data and the identification information as received through the transmission line including the second ring configuration; and
said control-program update data separation unit separates the update data from the communication data multiplexed with the update data and the identification information as selected by said selection unit.

9. The communication apparatus according to claim 8, wherein said control-program data update notification unit notifies whether an update of the data of the predetermined control program has been successful, to the communication apparatus being the transmission source of the update data of the predetermined control program, by using both the transmission line including the first ring configuration and the transmission line including the second ring configuration.

10. A remote program update method for remotely updating a predetermined control program of a communication apparatus forming a predetermined communication network as a node apparatus and having an operation controlled by the predetermined control program, the method comprising:
transmitting update data of the predetermined control program multiplexed with, at least in part with communication data, to another communication apparatus of the predetermined communication network;
separating the update data from the communication data, when the communication data multiplexed with the update data is received;
updating data of the predetermined control program in a pertinent apparatus, with the update data of the predetermined control program as separated at said separating; and
notifying whether an update of the data of the predetermined control program has been successful, to the communication apparatus being a transmission source of the update data of the predetermined control program;
wherein, in a case where said notifying indicates that the update of the data of the predetermined control program has been successful, said transmitting includes transmitting from the transmission source the update data of the predetermined control program multiplexed, at least in part with the communication data, to a corresponding communication apparatus that is a transmission destination again.
